(19) United States
(12) Patent Application Publication
(10) Pub. No.: US 2025/0136057 A1
(43) Pub. Date: May 1, 2025

(54) VEHICLE GLASS CONTAMINATION ASSESSMENT FOR OPTIMIZED AUTO-ACTIVATION OF CLEANING SYSTEM

(71) Applicant: GM Global Technology Operations LLC, Detroit, MI (US)

(72) Inventors: Alaa M. Khamis, Courtice (CA); William Cavalcante Araujo, Claremont, CA (US); Yun Qian Miao, Waterloo (CA); Julien P. Mourou, Bloomfield Hills, MI (US)

(21) Appl. No.: 18/499,362

(22) Filed: Nov. 1, 2023

(51) Int. Cl. B60S 1/48

(52) U.S. Cl. CPC B60S 1/486

(57) ABSTRACT

A vehicle includes a system for cleaning a contaminant from a surface of a vehicle. The system includes a camera for obtaining an image of the surface, the surface including the contaminant, a plurality of cleaning devices for cleaning the contaminant from the surface, and a processor. The processor is configured to determine a contamination measure from the image, the contamination measure indicative of a contamination level of the surface from the image, determine a contaminated region and a contaminant type from the image, select a cleaning approach for cleaning the surface based on the contamination measure, the contaminated region, and the contaminant type, the cleaning approach including selecting a cleaning device from the plurality of cleaning devices, selecting a cleaning direction and selecting a cleaning duration, and control the cleaning device using the cleaning approach.

### INTRODUCTION

The subject disclosure relates to cleaning systems in vehicles and, in particular, to a method of automated selection of an optimal approach for cleaning a surface of the vehicle based on an image of the surface.

During normal operation, a vehicle accumulates dirt, rain, snow and other contaminants on one or more of its surfaces, such as a windshield. The vehicle generally includes one or more cleaning systems that can be used to clean the contaminant(s) from a surface. The cleaning system can include multiple cleaning devices that are suitable for different contaminant types. The cleaning system is generally manually operated so that the driver can select an appropriate cleaning device and choose to apply, etc. To automate the cleaning system, it is necessary to be able to make the decisions that are otherwise made by the driver. Accordingly, it is desirable to provide a cleaning system that can automatically select an optimal approach for cleaning a contaminant from a surface of a vehicle.

### SUMMARY

In one exemplary embodiment, a method of cleaning a contaminant from a surface of a vehicle is disclosed. An image of the surface is obtained using a camera. A processor determines a contamination measure from the image, the contamination measure indicative of a contamination level of the surface from the image. The processor determines a contaminated region and a contaminant type from the image. The processor selects a cleaning approach for cleaning the surface based on the contamination measure, the contaminated region, and the contaminant type, the cleaning approach including selecting a cleaning device from a plurality of cleaning devices, selecting a cleaning direction and selecting a cleaning duration. The cleaning device is controlled using the cleaning approach.

In addition to one or more of the features described herein, the method further includes selecting the cleaning device, the duration and the orientation using a velocity of the vehicle.

In addition to one or more of the features described herein, the method further includes determining the contamination level based on an average size of the contaminant and a dispersion of the contaminant over the surface.

In addition to one or more of the features described herein, the method further includes determining the contaminant type and the contamination level from one of a single image when the vehicle is stationary and a plurality of temporally spaced images when the vehicle is in motion.

In addition to one or more of the features described herein, the method further includes determining the contaminated region using semantic segmentation of the image.

In addition to one or more of the features described herein, the method further includes inputting the image into one of a predictive model and a machine learning model to determine the contaminant type and the contamination level.

In addition to one or more of the features described herein, the method further includes comparing the image of the surface to a contamination model of the vehicle.

In another exemplary embodiment, a system for cleaning a contaminant from a surface of a vehicle is disclosed. The system includes a camera for obtaining an image of the surface, the surface including the contaminant, a plurality of cleaning devices for cleaning the contaminant from the surface, and a processor. The processor is configured to determine a contamination measure from the image, the contamination measure indicative of a contamination level of the surface from the image, determine a contaminated region and a contaminant type from the image, select a cleaning approach for cleaning the surface based on the contamination measure, the contaminated region, and the contaminant type, the cleaning approach including selecting a cleaning device from the plurality of cleaning devices, selecting a cleaning direction and selecting a cleaning duration, and control the cleaning device using the cleaning approach.

In addition to one or more of the features described herein, the processor is further configured to select the cleaning device, the duration and the orientation using a velocity of the vehicle.

In addition to one or more of the features described herein, the processor is further configured to determine the contamination level based on an average size of the contaminant and a dispersion of the contaminant over the surface.

In addition to one or more of the features described herein, the processor is further configured to determine the contaminant type and the contamination level from one of a single image when the vehicle is stationary, and a plurality of temporally spaced images when the vehicle is in motion.

In addition to one or more of the features described herein, the processor is further configured to determine the contaminated region using semantic segmentation of the image.

In addition to one or more of the features described herein, the processor is further configured to operate one of a predictive model and a machine learning model to determine the contaminant type and the contamination level based on the image.

In addition to one or more of the features described herein, the processor is further configured to compare the image of the surface to a contamination model of the vehicle.

In yet another exemplary embodiment, a vehicle is disclosed. The vehicle includes a camera for obtaining an image of the surface, the surface including the contaminant, a plurality of cleaning devices for cleaning the contaminant from the surface, and a processor. The processor is configured to determine a contamination measure from the image, the contamination measure indicative of a contamination level of the surface from the image, determine a contaminated region and a contaminant type from the image, select a cleaning approach for cleaning the surface based on the contamination measure, the contaminated region, and the contaminant type, the cleaning approach including selecting a cleaning device from the plurality of cleaning devices, selecting a cleaning direction and selecting a cleaning duration, and control the cleaning device using the cleaning approach.

In addition to one or more of the features described herein, the processor is further configured to select the cleaning device, the duration and the orientation using a velocity of the vehicle.

In addition to one or more of the features described herein, the processor is further configured to determine the contamination level based on an average size of the contaminant and a dispersion of the contaminant over the surface.

In addition to one or more of the features described herein, the processor is further configured to determine the contaminant type and the contamination level from one of a single image when the vehicle is stationary, and a plurality of temporally spaced images when the vehicle is in motion.

In addition to one or more of the features described herein, the processor is further configured to determine the contaminated region using semantic segmentation of the image.

In addition to one or more of the features described herein, the processor is further configured to operate one of a predictive model and a machine learning model to determine the contaminant type and the contamination level based on the image.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIGS. 2A-2C illustrate a cleaning device that can be used for cleaning a glass surface, in an illustrative embodiment;

FIG. 2D shows a side view of the cleaning device;

FIG. 2E shows a side view of the cleaning device in operation.

FIG. 3A illustrates an effect of vehicle speed on motion of contaminants or fluids on a glass surface, such as a windshield;

FIG. 3B illustrates cleaning directions for cleaning devices based on vehicle speed;

FIG. 4A shows a diagram illustrating a cleaning system in operation when the vehicle is moving at a first vehicle speed, in an embodiment;

FIG. 4B shows a diagram illustrating a cleaning system in operation when the vehicle is moving at a second vehicle speed, in an embodiment;

FIG. 5 illustrates a process flow for a method of cleaning a surface of the vehicle, in an illustrative embodiment;

FIG. 6 is a flowchart of a method for cleaning a surface of the vehicle, in an embodiment;

FIG. 7 shows a contamination model that can be used as a prior information for determining contamination type in an illustrative embodiment;

FIG. 8 depicts a vision-based clustering process for determining contaminated regions of a surface; and

FIG. 9 shows a flowchart of a method for detecting contaminants.

### DETAILED DESCRIPTION

The following description is merely exemplary in nature and is not intended to limit the present disclosure, its application or uses. It should be understood that throughout the drawings, corresponding reference numerals indicate like or corresponding parts and features.

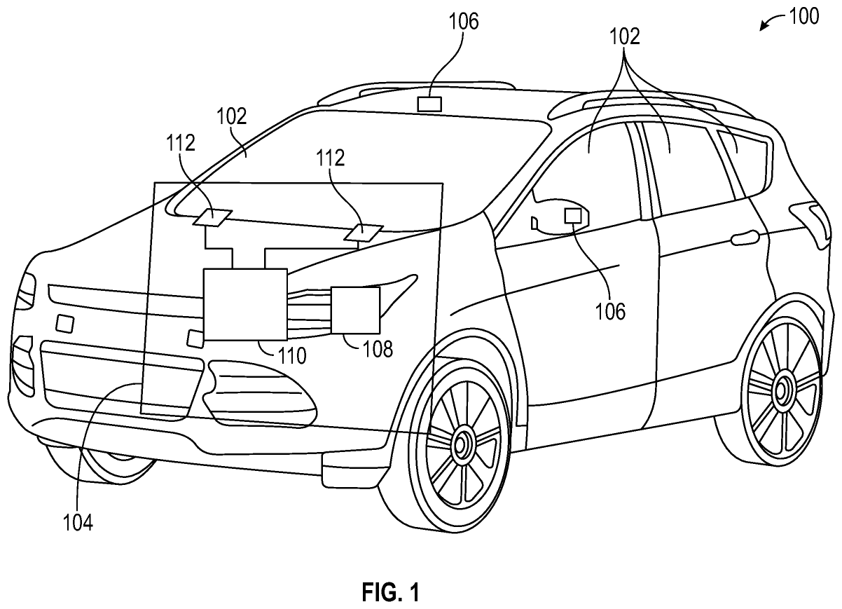

In accordance with an exemplary embodiment, FIG. 1 shows a vehicle 100. The vehicle 100 includes surfaces 102. These surfaces are capable of accumulating a contaminant or debris, such as fluid, rain, moisture, dirt, mud, etc. Such surfaces can include a windshield, windows, etc. The vehicle 100 includes a cleaning system 104 for cleaning the surfaces 102. The cleaning system 104 includes a plurality of cameras 106, a vehicle speed sensor 108, a controller 110, and one or more cleaning devices 112. Each camera 106 is associated with a surface 102 and is oriented toward its associated surface to be able to obtain an image of the associated surface. A camera 106 can be an internal camera (i.e., located within a cabin of the vehicle 100) or an external camera. A single camera or multiple cameras can be associated with a surface. Each camera 106 is in communication with the controller 110 and can send its images to the controller 110. The camera 106 can send either a single image or a sequence of images, in various embodiments. The vehicle speed sensor 108 provides a measurement of vehicle speed to the controller 110.

The one or more cleaning devices 112 includes, but are not limited to, a wiper, an electrowetting device, an air nozzle, a cleaning fluid device, an oscillation device, a heater, etc. A single cleaning device or multiple cleaning devices can be associated with a surface. Each cleaning device 112 can be activated by a signal from the controller 110 to clean the contaminant from its associated surface 102.

The controller 110 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 110 may include a non-transitory computer-readable medium that stores instructions which, when processed by one or more processors of the controller 110, implements a method of determining a contaminant type, location of the contaminant and a contamination level on a surface of the vehicle, and of determining an approach for cleaning the surface, including selecting a cleaning device, a duration for activation of the cleaning device and an orientation of the cleaning device. The controller 110 can then send a signal to activate the selected cleaning device for the selected time and at the selected orientation, according to one or more embodiments detailed herein. A cleaning duration can be for example, 3 seconds (for low), 6 seconds (for medium) and 9 seconds (for high).

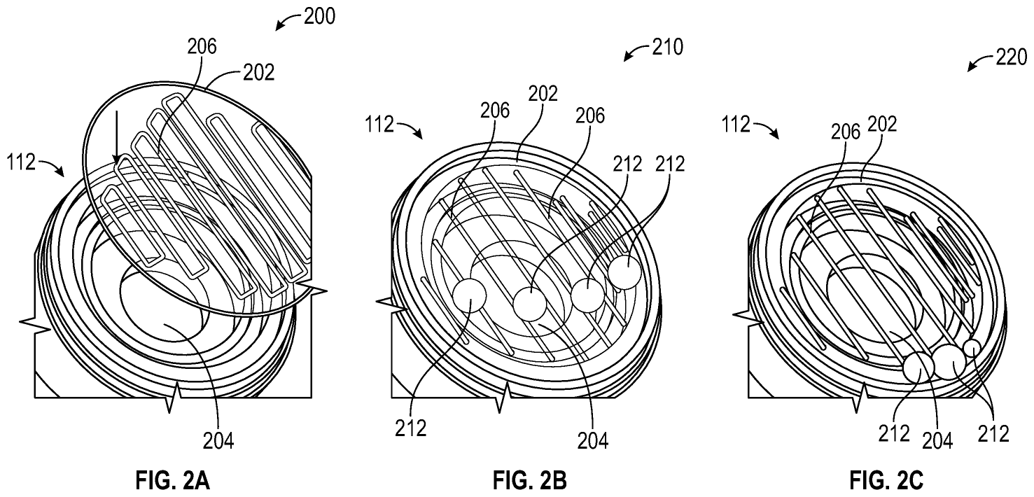

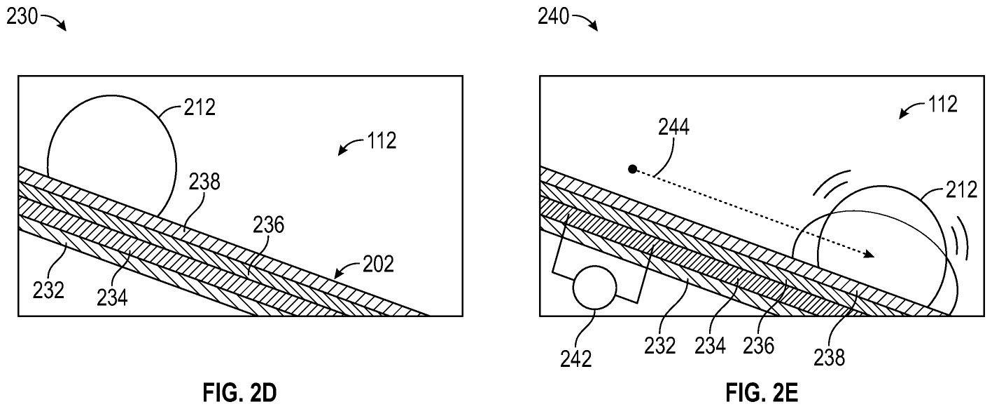

FIGS. 2A-2C illustrate a cleaning device 112 that can be used for cleaning a glass surface, in an illustrative embodiment. Similar cleaning devices are disclosed in U.S. application Ser. No. 17/534,180 and U.S. application Ser. No. 17/741,740, assigned to General Motors Company, the contents of which are incorporated herein by reference in their entirety. FIG. 2A shows a perspective view 200 illustrating the components of the cleaning device 112. The cleaning device 112 includes a multifunctional glass 202 that is placed over a camera 204. The multifunctional glass 202 is shown separated from the camera 204, for ease of illustration. The multifunctional glass 202 includes multiple layers, one of which includes a plurality of electrodes 206. FIG. 2B shows a perspective view 210 with a contaminant 212 accumulated on the multifunctional glass 202. FIG. 2C shows a perspective view 220 illustrating operation of the cleaning device. The electrodes 206 are activated in a periodic sequence, thereby causing the contaminant 212 to oscillate and be moved to one side of the multifunctional glass 202.

FIG. 2D shows a side view 230 of the cleaning device 112. The multifunction glass 202 includes a several layers, including a substrate 232 on an inside of the vehicle. An electrode layer 234 is on top of the substrate 232. A dielectric layer 236 is on top of the electrode layer 234. A hydrophobic layer 238 is on top of the electrode layer 234 and faces the outside of the vehicle. A contaminant 212 is shown in on the hydrophobic layer.

FIG. 2E shows a side view 240 of the cleaning device 112 in operation. A voltage source 242 applies a periodic voltage across the electrode layer 234 to create a force on the contaminant 212 that moves the contaminant in a selected direction 244. The voltage source 242 can be operated to move the contaminant either in the selected direction 244 shown in FIG. 2E or in the opposite direction.

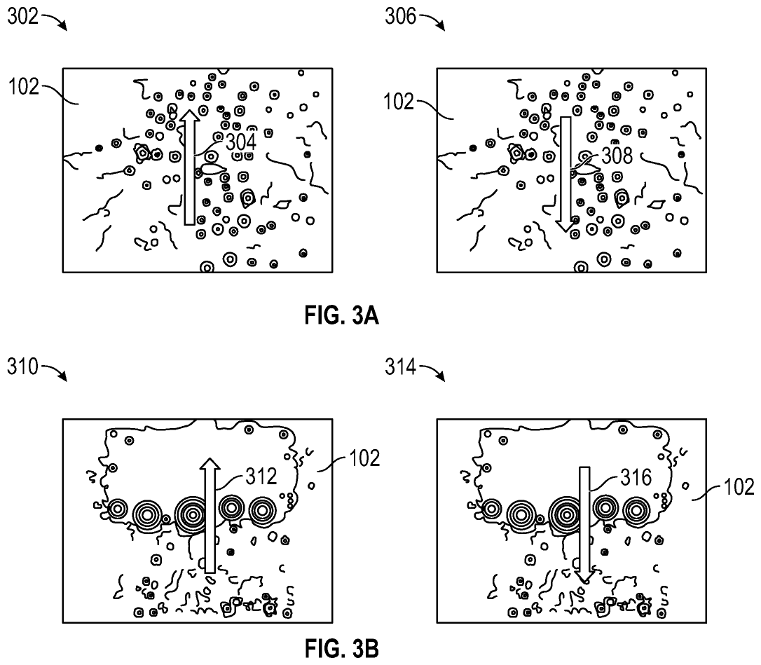

FIG. 3A illustrates an effect of vehicle speed on motion of contaminants or fluids on a surface 102, such as a windshield. Frame 302 shows a fluid direction when the vehicle is moving at a first vehicle speed vₛ which is greater than a speed threshold v_{T}, without use of any cleaning devices. At vehicle speeds above the speed threshold v_{T}, a contaminant is carried up the windshield due to a drag on the droplet, as indicated by drag arrow 304.

Frame 306 shows a fluid direction when the vehicle is moving at a second vehicle speed vₛ which is less than the speed threshold v_{T}, without use of any cleaning devices. The second vehicle speed can include the vehicle being at rest or the vehicle moving backward. At this speed, a contaminant on the windshield is naturally carried down the windshield by gravity, as indicated by gravity arrow 308.

FIG. 3B illustrates cleaning directions for the cleaning devices(s) based on vehicle speed. Frame 310 shows a cleaning direction for when the vehicle is moving with vₛ>v_{T}. The cleaning direction is indicated by cleaning arrow 312. Cleaning arrow 312 is in the same direction as the drag arrow 304 of FIG. 3A.

Frame 314 shows a cleaning direction for when the vehicle is moving with vₛ<v_{T}. The cleaning direction is indicated by cleaning arrow 316 which is in the same direction as the gravity arrow 308 of FIG. 3A.

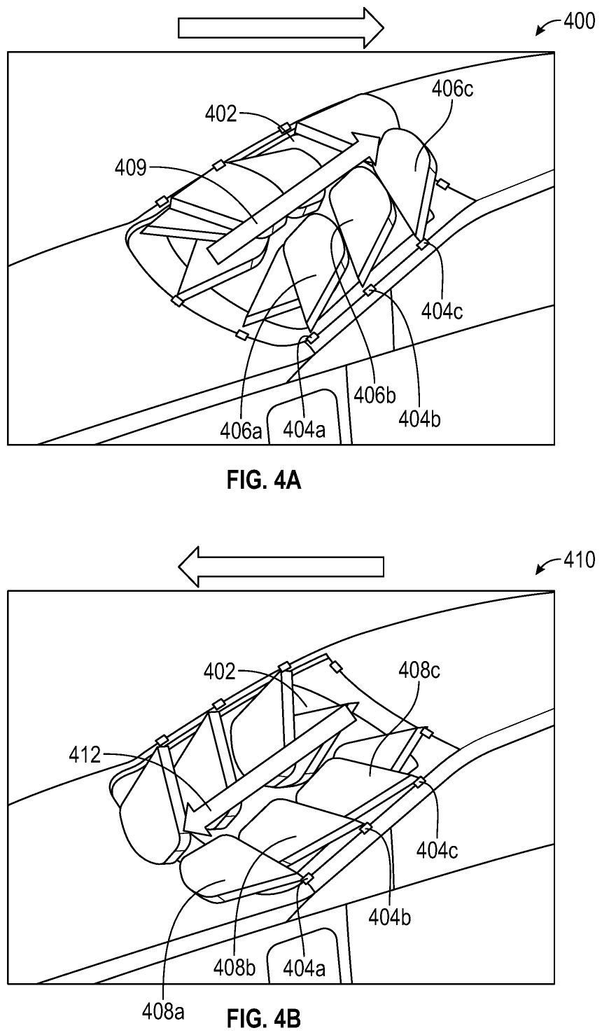

FIGS. 4A and 4B show operation of a cleaning system based on a vehicle speed. FIG. 4A shows a perspective view 400 of a windshield 402 of the vehicle illustrating a cleaning system in operation when the vehicle is moving at the first vehicle speed (i.e., with vₛ>v_{T}), in an embodiment. The windshield 402 is shown with nozzles 404A-404C at different locations along its perimeter. Each nozzle 404A-404C is configured to spray cleaning fluid onto an associated region 406A-406C of the windshield 402. The regions 406A-406C can overlap each other and can cover an entirety of the windshield 402 or a viewing area of the windshield.

The nozzles 404A-404C are oriented to spray cleaning fluid onto the windshield with an upward velocity component 409. Thus, the cleaning fluid imparts a force on the contaminant in the same direction that the contaminant is being dragged, thereby allowing the contaminant to be removed quickly and efficiently from the windshield at the top edge thereof.

FIG. 4B shows a perspective view 410 of the windshield 402 illustrating a cleaning system in operation when the vehicle is moving at the second vehicle speed (i.e., with vₛ<v_{T}), in an embodiment. The nozzles 404A-404C are oriented to spray cleaning fluid onto the windshield (e.g., onto associated regions 408A-408C) with a downward velocity component 412. Thus, the cleaning fluid imparts a force on the contaminant that allows the contaminant to be removed quickly and efficiently from the windshield at the bottom edge thereof.

It is noted that the associated regions 408A-408C (of the nozzles 404A-404C) in FIG. 4B are different than the regions 406A-406C of FIG. 4A. The nozzles 404A-404C can be configured to spray cleaning fluid either with the upward component or with the downward component, based on a signal from the controller. Alternatively, the nozzles 404A-404C of FIG. 4A includes a first set of nozzles oriented to spray cleaning fluid with an upward component along the windshield and the nozzles 404A-404C of FIG. 4B includes a second set of nozzles oriented to spray cleaning fluid with a downward component along the windshield.

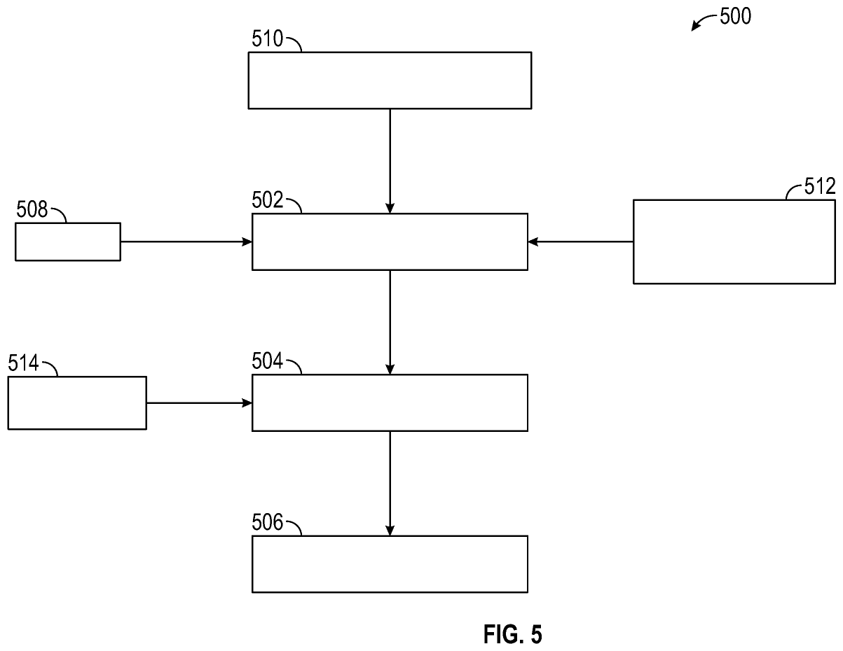

FIG. 5 illustrates a process flow 500 for a method of cleaning a surface of the vehicle, in an illustrative embodiment. The process flow 500 includes operation of various modules on a processor, including a detection and characterization module 502, an action map module 504 and a cleaning module 506. The detection and characterization module 502 detects the presence of a contaminant on a surface and determines the contaminant type (e.g., dirt, dust, rain, snow, insects, etc.) as well as contaminated regions of the surface (i.e., locations of the windshield which includes contaminants), and a contamination level.

The detection and characterization module 502 receives input from various devices, including one or more images 508 from a camera 106, contamination model 510 from a database, and a contamination threshold 512. In various embodiments, a predictive model or a machine learning model can be used to identify the contamination and determine a contamination level. The images, contamination model and contamination threshold can be input to the predictive model or the machine learning model network, which can compare the images to the contamination model to identify the contaminant type, contamination level and contaminated regions. In various embodiments, the machine learning model is a neural network. The action map module 504 receives a vehicle speed 514 from the vehicle speed sensor 108 as well as the contamination type, contamination level and contaminated regions from the detection and characterization module 502. The action map module 504 selects a cleaning approach, including one or more cleaning devices, a cleaning duration, and a cleaning direction, based on these inputs. The action map module 504 sends the selected cleaning approach, cleaning duration and cleaning direction to the cleaning module 506, which activates the selected cleaning device for the selected cleaning duration and along the selected cleaning direction.

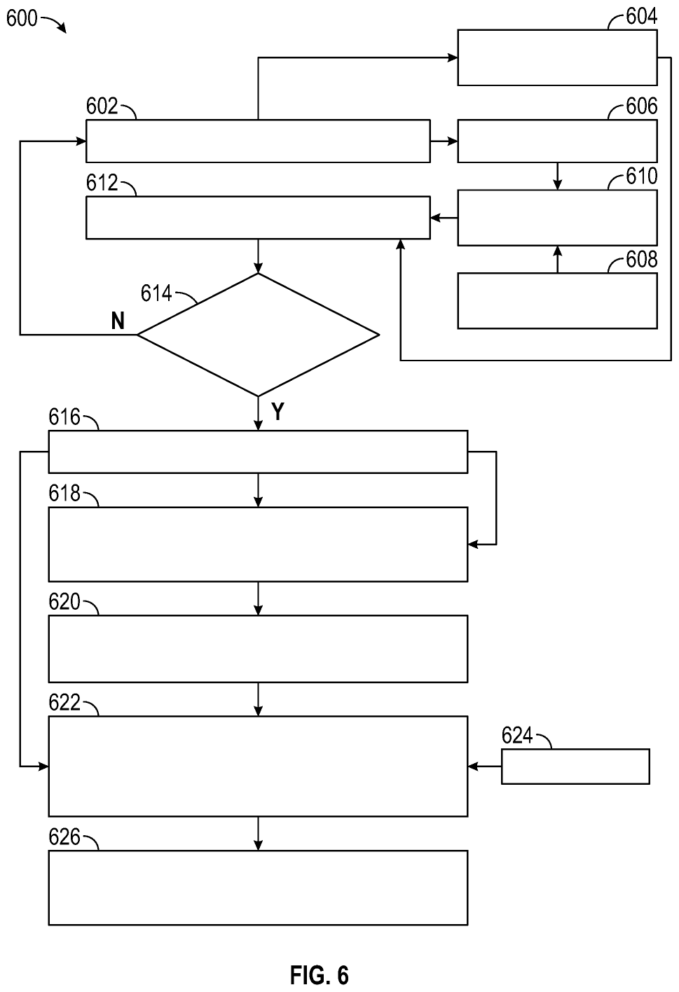

FIG. 6 is a flowchart 600 of a method for cleaning a surface of the vehicle, in an embodiment. In box 602, one or more images are received. The one or more images can be used to establish an image quality metric that can be used for future testing and/or for determining a cleaning approach for cleaning the surface of the vehicle. In box 604, the image is used to establish a reference image that can be later used to define a quality metric. Exemplary metrics include, but are not limited to, an image quality index (IQI), a structural similarity index measure (SSIM), a variance inflation factor (VIF), a feature similarity index (FSIM) and a peak signal-to-noise ratio (PSNR). A reference image can be one that is taken with the vehicle in a location with good conditions, such as in a garage or other place having a good lighting.

Returning to box 602, the image is sent to box 606. In box 606, a window region is detected having the contamination. Alternatively, in box 608, a window bounding box can also be extracted from a three-dimensional geometric model of the vehicle. In box 610, the window bounding box and/or the window region are considered the region of interest for subsequent analysis.

In box 612, the quality of the images is characterized for the region of interest. Characterizing the quality can result in an image quality index (IQI). In box 614, if the image quality index is less than a quality threshold, (IQI<Q_{T}) the method returns to box 602, at which more images are received. Otherwise, the method proceeds to box 616. In box 616, the image is processed to determine contaminant type from the image.

In box 618, the processor performs semantic segmentation on the image to calculate a contamination measure of the surface that quantifies a level of contamination. The contamination measure M can be calculated as shown in Eq. (1):

$$M = {ω}_{1} \times {S}_{av} + {ω}_{2} \times σ \qquad Eq . ( 1 )$$

where Sₐᵥ is an average size of the contaminants, σ is a dirt dispersion (such as inter quartile range) and ω₁ and ω₂ are weights in which

$${ω}_{1} + {ω}_{2} = 1 \qquad Eq . ( 2 )$$

In box 620, the contamination measure M is compared to a contamination threshold D_{T} to determine a contamination level. The contamination threshold is a calibratable quantity. In an embodiment, the contamination threshold can be established using the reference image (box 604). For M>=D_{T}, the contamination level is defined as high and for M<D_{T}, the contamination level is defined as low.

In box 622, an action map is used to determine a cleaning approach. The action map receives input such as contamination type (from box 616), a contamination level (from box 620) and vehicle speed (from box 624) and output the cleaning approach, including a selected cleaning device, duration for activation and device orientation. Table I outlines an illustrative action map, including illustrative inputs and illustrative outputs.

TABLE 1

| Inputs | | | Outputs | |
|---|---|---|---|---|
| Vehicle | Contamination | Contamination | Cleaning | |
| Speed | Type | Measure | Duration | Cleaning Approach |
| Low/Parked | Rain | Low | Low | Electrowetting Forward |
| | | High | High | Air/Electrowetting Forward |
| High | Rain | Low | Low | Electrowetting Backward |
| | | High | High | Air/Electrowetting Backward |
| Low/Parked | Insects | Low | High | Washer Fluid/Electrowetting |
| | | | | Forward |
| | | High | High | Washer Fluid/Electrowetting |
| | | | | Forward |
| High | Insects | Low | High | Washer Fluid/Electrowetting |
| | | | | Backward |
| | | High | High | Washer Fluid/Air/ |
| | | | | Electrowetting Backward |
| Low/Parked | Snow | Low | Low | Air/Electrowetting Forward |
| | | High | High | Washer Fluid/Air/ |
| | | | | Oscillation Forward |
| High | Snow | Low | Low | Air/Electrowetting Backward |
| | | High | High | Washer Fluid/Air/ |
| | | | | Electrowetting Backward |
| Low/Parked | Mud | Low | Low | Air/Oscillation Forward |
| | | High | High | Washer Fluid/Air/ |
| | | | | Electrowetting Forward |
| High | Mud | Low | Low | Air/Electrowetting Backward |
| | | High | High | Washer Fluid/Air/ |
| | | | | Electrowetting Backward |
| Low/Parked | Dust | Low | Low | Air/Electrowetting Forward |
| | | High | High | Air/Electrowetting Forward |
| High | Dust | Low | Low | Air/Electrowetting Backward |
| | | High | High | Air/Electrowetting Backward |

In box 626, the selected cleaning device is controlled or activated using the cleaning approaches selected using the action map.

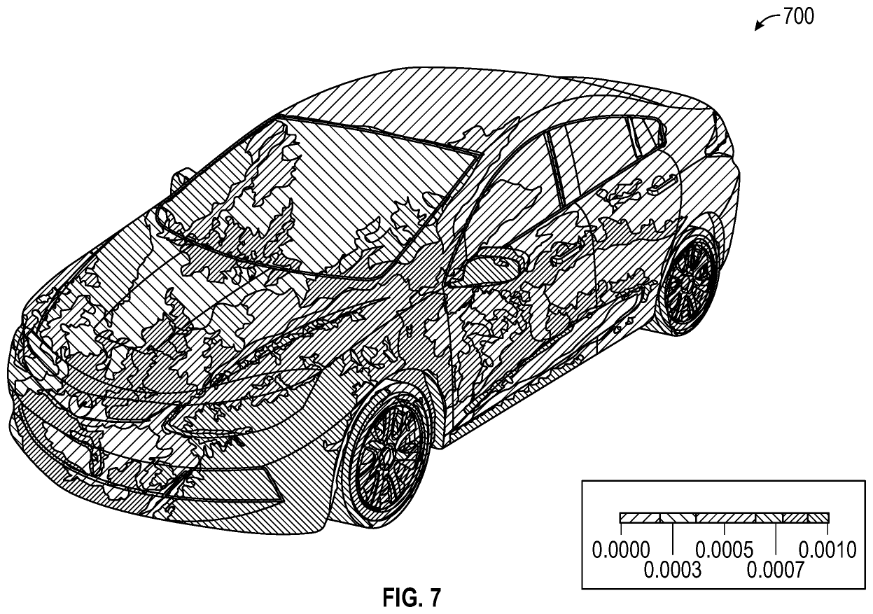

FIG. 7 shows a contamination model 700 that can be used as a prior information for determining contamination type in an illustrative embodiment. The contamination model can be generated through simulation or through field operations. The contamination model includes a three-dimensional model of the vehicle which is coated with grains indicating the deposition locations of contaminants through operation of the vehicle in a given situation (i.e., dirt road, wet pavement, etc.). The grains can indicate location and thickness of a layer of contaminants, among other parameters.

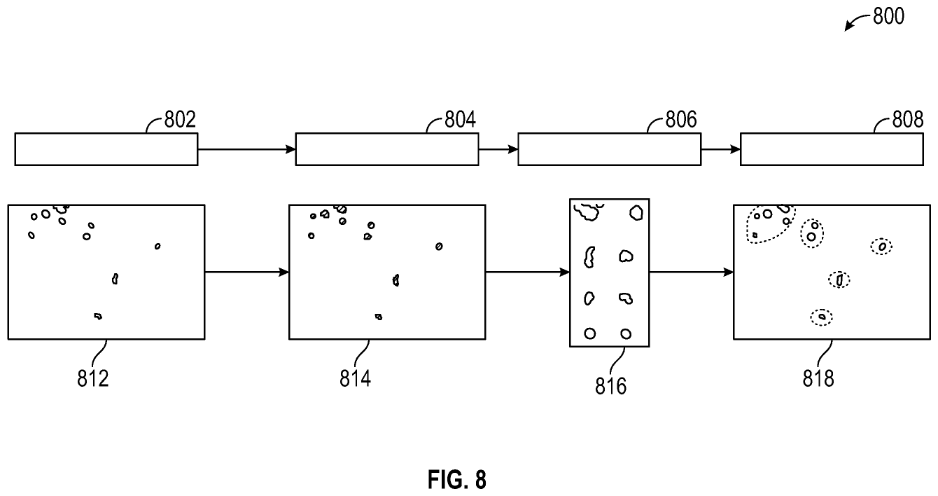

FIG. 8 depicts a vision-based clustering process 800 for determining contaminated regions of a surface. In an embodiment, the vision-based clustering can be performed using a predictive model or a machine learning model. In box 802, an image 812 is received. In box 804, semantic segmentation is performed on the image 812 to associate a label or category to different pixels in the image, as shown in segmentation image 814. In box 806, outliers are identified in the segmented image. The outliers can be determined from a feature extraction process. Outlier image 816 shows various outliers. In box 808, a cluster method is performed to generate representative contamination clusters from the outliers, as shown in cluster image 818.

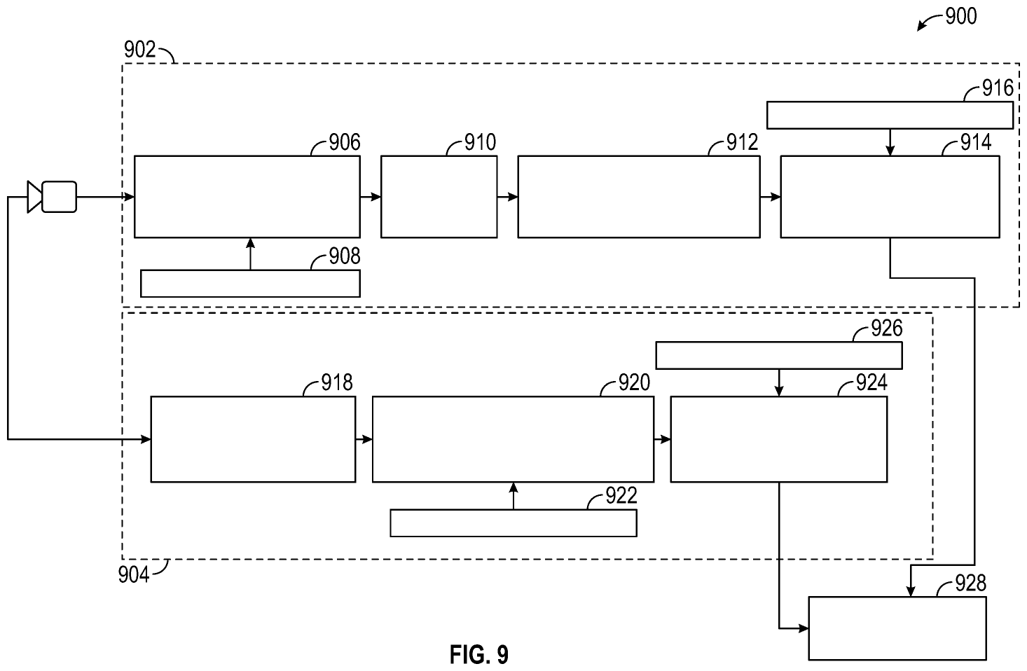

FIG. 9 shows a flowchart 900 of a method for detecting contaminants. The method includes a multiple image branch 902 and a single image branch 904. The camera(s) can provide image(s) to either branch.

The multiple image branch 902 involves determining contaminants using a plurality of images. The plurality of images includes temporally spaced images from a selected camera. In box 906, the processor extracts salient regions from the images and tracks the motion of the salient regions over time. The extraction and tracking process involves the use of motion information from the vehicle (i.e., wheel speed, steering angle, etc.) as shown in box 908. In box 910, the tracking is used to detect blockage areas. In box 912, a contamination map is generated using a motion-based vision obstruction program. In box 914, a contamination level is determined, and clusters are formed to locate contaminated regions. The contamination level can be determined based on a first threshold (box 916), which can be a calibrated quantity.

The single image branch 904 involves determining contaminants using a single image. In box 918, a single image is received from a camera. Vehicle speed is not needed. In box 920, the image is compared to the contamination model, which is provided in box 922. In box 924, a contamination level is determined, and contamination clusters are generated. The contamination level can be determined using a second threshold, shown in box 926. The contamination level can be calibratable.

In box 928, the output (contamination level and clustering) from the multiple image branch 902 and the output (contamination level and clustering) from the single image branch 904 are fused to obtain a final contamination level and final clustering map.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of cleaning a contaminant from a surface of a vehicle, comprising:
obtaining an image of the surface using a camera;
determining, at a processor, a contamination measure from the image, the contamination measure indicative of a contamination level of the surface from the image;
determining, at the processor, a contaminated region and a contaminant type from the image;
selecting, at the processor, a cleaning approach for cleaning the surface based on the contamination measure, the contaminated region, and the contaminant type, the cleaning approach including selecting a cleaning device from a plurality of cleaning devices, selecting a cleaning direction and selecting a cleaning duration; and
controlling the cleaning device using the cleaning approach.

2. The method of claim 1, further comprising selecting the cleaning device, the duration and the orientation using a velocity of the vehicle.

3. The method of claim 1, further comprising determining the contamination level based on an average size of the contaminant and a dispersion of the contaminant over the surface.

4. The method of claim 1, further comprising determining the contaminant type and the contamination level from one of: (i) a single image when the vehicle is stationary; and (ii) a plurality of temporally spaced images when the vehicle is in motion.

5. The method of claim 1, further comprising determining the contaminated region using semantic segmentation of the image.

6. The method of claim 1, further comprising inputting the image into one of a predictive model and a machine learning model to determine the contaminant type and the contamination level.

7. The method of claim 1, further comprising comparing the image of the surface to a contamination model of the vehicle.

8. A system for cleaning a contaminant from a surface of a vehicle, comprising:
a camera for obtaining an image of the surface, the surface including the contaminant;
a plurality of cleaning devices for cleaning the contaminant from the surface; and
a processor configured to:
determine a contamination measure from the image, the contamination measure indicative of a contamination level of the surface from the image;
determine a contaminated region and a contaminant type from the image;
select a cleaning approach for cleaning the surface based on the contamination measure, the contaminated region, and the contaminant type, the cleaning approach including selecting a cleaning device from the plurality of cleaning devices, selecting a cleaning direction and selecting a cleaning duration; and
control the cleaning device using the cleaning approach.

9. The system of claim 8, wherein the processor is further configured to select the cleaning device, the duration and the orientation using a velocity of the vehicle.

10. The system of claim 8, wherein the processor is further configured to determine the contamination level based on an average size of the contaminant and a dispersion of the contaminant over the surface.

11. The system of claim 8, wherein the processor is further configured to determine the contaminant type and the contamination level from one of: (i) a single image when the vehicle is stationary; and (ii) a plurality of temporally spaced images when the vehicle is in motion.

12. The system of claim 8, wherein the processor is further configured to determine the contaminated region using semantic segmentation of the image.

13. The system of claim 8, wherein the processor is further configured to operate one of a predictive model and a machine learning model to determine the contaminant type and the contamination level based on the image.

14. The system of claim 8, wherein the processor is further configured to compare the image of the surface to a contamination model of the vehicle.

15. A vehicle, comprising:
a camera for obtaining an image of the surface, the surface including the contaminant;
a plurality of cleaning devices for cleaning the contaminant from the surface; and
a processor configured to:
determine a contamination measure from the image, the contamination measure indicative of a contamination level of the surface from the image;
determine a contaminated region and a contaminant type from the image;
select a cleaning approach for cleaning the surface based on the contamination measure, the contaminated region, and the contaminant type, the cleaning approach including selecting a cleaning device from the plurality of cleaning devices, selecting a cleaning direction and selecting a cleaning duration; and
control the cleaning device using the cleaning approach.

16. The vehicle of claim 15, wherein the processor is further configured to select the cleaning device, the duration and the orientation using a velocity of the vehicle.

17. The vehicle of claim 15, wherein the processor is further configured to determine the contamination level based on an average size of the contaminant and a dispersion of the contaminant over the surface.

18. The vehicle of claim 15, wherein the processor is further configured to determine the contaminant type and the contamination level from one of: (i) a single image when the vehicle is stationary; and (ii) a plurality of temporally spaced images when the vehicle is in motion.

19. The vehicle of claim 15, wherein the processor is further configured to determine the contaminated region using semantic segmentation of the image.

20. The vehicle of claim 15, wherein the processor is further configured to operate one of a predictive model and a machine learning model to determine the contaminant type and the contamination level based on the image.
